(19) United States
(12) Patent Application Publication
(10) Pub. No.: US 2002/0107765 A1
(43) Pub. Date: Aug. 8, 2002

(54) Electronic financing system

(76) Inventor: Timothy Walker, Tustin, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/737,168

(22) Filed: Dec. 13, 2000

(51) Int. Cl. G06F 17/60

(52) U.S. Cl. 705/35

(57) ABSTRACT

An on-line system for approving credit applications is described. The system includes a qualification module for determining which bank should receive a particular consumer's credit application. If the bank denies the credit application, the system automatically analyzes the reason for the rejection and attempts to find a suitable product substitute for the consumer that will be approved by the original bank, or another lender.

### BACKGROUND OF THE INVENTION

1. Field of the Invention

This invention relates to systems and methods for determining financing options for a consumer. More specifically, this invention relates to systems and methods for electronically determining financing options for purchasing automobiles.

2. Description of the Related Art

The Internet has greatly eased the communication process between an automobile dealership and automobile consumers. However, over ninety percent of all automobile purchases are still made by personal visits of consumers to an automobile dealership. Thus, it is still very important for dealerships to provide consumers with many options to assist them in purchasing an automobile. Such options can include purchase financing, leasing and insurance.

Currently, when a consumer desires to purchase an automobile, they discuss the financing options with specialist at the dealership. The financing specialist inputs the consumer's credit information into a computer, which generates a score based on the consumer's credit history. A consumer with a very good credit history might have a very high score, while a consumer with a poor credit history would have a low score.

Unfortunately, once the credit score has been generated, the dealership does not have a convenient mechanism for analyzing the best loan or lease for the consumer and the dealership. For example, the dealership might make more money on the sale by financing the loan through a bank that pays a commission to the dealership. Similarly, the dealership may make more profit by leasing the automobile through a vendor that pays a fee to the dealership for every lease agreement. Embodiments of the invention addresses this need for a computerized method of assisting a dealership find the most advantageous financing options for the consumer and the dealership.

### SUMMARY OF THE INVENTION

One embodiment of the invention is an electronic vehicle loan approval system that includes: an electronic vehicle loan application, wherein the application permits entry of loan data and first vehicle data from a vehicle dealership; a credit score module comprising computer readable instructions to accept the loan data, process it in accordance with a predetermined credit score formula and provide a credit score for a consumer; a qualification module comprising computer readable instructions to electronically submit said credit score to a plurality of banks and receive a list of banks that approve the loan; and an ordering module comprising computer readable instructions for ordering the list of loans based on their value to the vehicle dealership.

Another embodiment of the invention is a computerized method of determining the most advantageous loan application for a vehicle dealership. This method includes: determining a credit score of an electronic vehicle loan application for a first vehicle submitted by a vehicle dealership; comparing the credit score with a predetermined bank lending criteria to determine if the loan application meets the lending requirements of one or more banks; submitting the loan application to the one or more banks if the lending criteria has been met; receiving a denial of loan approval from the one or more banks, wherein responsive to said denial, a second vehicle is selected from an inventory of vehicles; resubmitting the loan application for the second vehicle to the one or more banks; and ordering the list of approved loans based on their revenue to the dealership.

Yet another embodiment of the invention is a system for approving a vehicle loan application that provides: means for determining a credit score of an electronic vehicle loan application for a first vehicle submitted by a vehicle dealership; means for comparing the credit score with a predetermined bank lending criteria to determine if the loan application meets the lending requirements of one or more banks; means for submitting the loan application to the one or more banks if the lending criteria has been met; means for receiving a denial of loan approval from the one or more banks, wherein responsive to said denial, a second vehicle is selected from an inventory of vehicles; means for resubmitting the loan application for the second vehicle to the one or more banks; and means for ordering the list of approved loans based on their revenue to the dealership.

### BRIEF DESCRIPTION OF THE DRAWINGS

FIG. 1 is a block diagram of one embodiment of an electronic financing system.

FIG. 2 is a flow diagram illustrating one embodiment of a process of obtaining financing from a lender.

FIG. 3 is a flow diagram illustrating one embodiment of the Generate Finance Options process of FIG. 2.

FIG. 4 is a flow diagram illustrating one embodiment of the Send Credit Applications to Bank process of FIG. 3.

FIG. 5 is a flow diagram illustrating one embodiment of the Analyze Received Data process of FIG. 3.

### DETAILED DESCRIPTION DEFINITIONS

A. Instructions

Instructions refer to computer-implemented steps for processing information in the financing system. Instructions can be implemented in software, firmware or hardware and include any type of programmed step undertaken by modules of the electronic financing system.

B. LAN

One example of the Local Area Network may be a corporate computing network, including access to the Internet, to which computers and computing devices comprising the financing system are connected. In one embodiment, the LAN conforms to the Transmission Control Protocol/Internet Protocol (TCP/IP) industry standard. In alternative embodiments, the LAN may conform to other network standards, including, but not limited to, the International Standards Organization's Open Systems Interconnection, IBM's SNA, Novell's Netware, and Banyan VINES.

C. Microprocessor

The microprocessor may be any conventional general purpose single- or multi-chip microprocessor such as a Pentium® processor, a Pentium® Pro processor, a 8051 processor, a MIPS® processor, a Power PC® processor, or an ALPHA® processor. In addition, the microprocessor may be any conventional special purpose microprocessor such as a digital signal processor or a graphics processor. The microprocessor typically has conventional address lines, conventional data lines, and one or more conventional control lines.

D. Modules

The electronic financing system is comprised of various modules as discussed in detail below. As can be appreciated by one of ordinary skill in the art, each of the modules comprise various sub-routines, procedures, definitional statements, and macros. Each of the modules are typically separately compiled and linked into a single executable program. Therefore, the following description of each of the modules is used for convenience to describe the functionality of the electronic financing system. Thus, the processes that are undergone by each of the modules may be arbitrarily redistributed to one of the other modules, combined together in a single module, or made available in, for example, a shareable dynamic link library.

E. Networks

The electronic financing system may include any type of electronically connected group of computers including, for instance, the following networks: Internet, Intranet, Local Area Networks (LAN) or Wide Area Networks (WAN). In addition, the connectivity to the network may be, for example, remote modem, Ethernet (IEEE 802.3), Token Ring (IEEE 802.5), Fiber Distributed Datalink Interface (FDDI) or Asynchronous Transfer Mode (ATM). Note that computing devices may be desktop, server, portable, hand-held, set-top, or any other desired type of configuration. As used herein, an Internet includes network variations such as public internet, a private internet, a secure internet, a private network, a public network, a value-added network, an intranet, and the like.

F. Operating Systems

The electronic financing system may be used in connection with various operating systems such as: UNIX, Disk Operating System (DOS), OS/2, Windows 3.X, Windows 95, Windows 98, and Windows NT.

G. Programming Languages

The electronic financing system may be written in any programming language such as C, C++, BASIC, Pascal, Java, and FORTRAN and ran under the well-known operating system. C, C++, BASIC, Pascal, Java, and FORTRAN are industry standard programming languages for which many commercial compilers can be used to create executable code.

H. Transmission Control Protocol

Transmission Control Protocol (TCP) is a transport layer protocol used to provide a reliable, connection-oriented, transport layer link among computer systems. The network layer provides services to the transport layer. Using a two-way handshaking scheme, TCP provides the mechanism for establishing, maintaining, and terminating logical connections among computer systems. TCP transport layer uses IP as its network layer protocol. Additionally, TCP provides protocol ports to distinguish multiple programs executing on a single device by including the destination and source port number with each message. TCP performs functions such as transmission of byte streams, data flow definitions, data acknowledgments, lost or corrupt data re-transmissions, and multiplexing multiple connections through a single network connection. Finally, TCP is responsible for encapsulating information into a datagram structure.

Overview

Embodiments of the present invention relate to financial methods and systems that allow an automobile dealership to compare and contrast the various types of financing, leasing and insurance options they might provide a vehicle consumer. The system is designed to access, transmit, process and approve electronic loan, lease and insurance applications from the dealership.

Several modules will be described hereafter. The modules may advantageously be implemented as one or more computer program modules configured to reside on an addressable storage medium operably connected to one or more microprocessors. The modules may advantageously be configured to execute on the one or more microprocessors.

Computer networks suitable for use with the embodiments of the invention include local area networks (LAN), wide area networks (WAN), Internet, or other connection services and network variations such as the World Wide Web, the public internet, a private internet, a private computer network, a secure internet, a private network, a public network, a value-added network, and the like. The computers connected to the network may be any microprocessor controlled device that permits access to the network, including terminal devices, such as personal computers, workstations, servers, mini computers, main-frame computers, laptop computers, mobile computers, palm top computers, hand held computers, set top box for a TV, or a combination thereof. The computers may further possess input devices such as a keyboard or a mouse, and output devices such as a computer screen or a speaker. The computer network may include one or more LANs, WANs, Internets, and computers. The computers may serve as servers, clients, or a combination thereof.

In one embodiment, the system described below conforms to the Transmission Control Protocol/Internet Protocol (TCP/IP) industry standard. In other embodiments, the system may conform to other network standards, including, but not limited to, the International Standards Organization's Open Systems Interconnection, IBM's SNA®, Novell's Netware®, and Banyan VINES®, that facilitate communication between the attached devices.

In one embodiment, the system is part of a Dealer Real-time Network, as described in U.S. patent application Ser. No. 09/231,415, entitled REAL-TIME VEHICLE PURCHASE REQUEST MANAGEMENT METHOD AND SYSTEM, and filed on Jan. 14, 1999, which is hereby incorporated by reference in its entirety.

In another embodiment, the financing specialist at the dealership enters the consumers credit information into a Dealer Financing System. The system is linked, as described below, to a variety of credit rating agencies, banks, finance companies and used car databases. A consumer, or the financing specialist, completes an electronic loan application by entering information into a Hypertext Markup Language (HTML) form and transmits that application through a wide area network to a main computer. The main computer electronically accesses the credit history of the consumer and determines a credit score based on the consumer's payment history and other criteria. A high score, for example, indicates that the consumer will qualify for a relatively high loan amount, whereas a low score indicates that a consumer will qualify for a relatively low loan amount.

Accessible from the main computer is a module that provides a series of loan qualification criteria filters that reflect the lending policies of a plurality of banks. For example, one particular bank might make loans to individuals having greater than $50,000 per year of income and a credit score of 100 or more. However, a second bank might specialize in loans to individuals having under $50,000 per year of income and a credit score of 80 or more. Instructions within the main computer analyze the credit score data and other information from the consumer to determine which bank, or set of banks, would be most likely to accept a loan from the consumer.

Once a set of appropriate banks or credit institutions has been identified by the instructions within the main computer, all of the credit data on the consumer, along with an identification code for the product being purchase are sent electronically to each bank's computer system in a format that allows the credit data to be analyzed by the bank automatically, or manually by the bank's underwriters. In one implementation, the data is encrypted and sent across the Internet. Such data transfers are preferably in a structured document format, such as the Extensible Markup Language (XML). More information on this data format can be found on the Internet at www.xml.org or www.xml.com.

Once a decision has been made whether or not to fund the particular loan, each bank electronically replies to the main computer. The identities of those banks that have agreed to fund the loan are sent to the financing specialist, along with the loan terms from each bank. Thus, the financing specialist can compare the term, interest rate and penalty clauses of each loan or lease in order to select the most advantageous loan program.

If one of the banks denies funding the loan or lease, instructions within the main computer analyze the denial to determine the reason for refusal to fund the load. For example, the bank may send a denial code that indicates that the product being purchased is too expensive in view of the consumer's credit score. Instructions within the main computer thereafter attempt to determine a similar, less expensive product that would fit within the lending criteria of the bank, and also be an acceptable alternative for the consumer.

In one embodiment, the consumers are vehicle consumers, and the products are automobiles and other vehicles. Thus, in this embodiment, the instructions in the main computer system would analyze an inventory of available automobiles that were similar to the chosen automobile, but less expensive. For example, if the originally requested vehicle was a $35,000 four door sedan with leather seats and air conditioning, the system would determine the most similar car at a lower price. The instructions would then instruct the main computer to resubmit the loan application to the same bank, or all of the banks, using the alternate automobile information.

It should be noted that the alternate automobile might be the same make and model of automobile that was originally selected by the consumer, but not include some expensive options. Alternatively, the instructions might retrieve an earlier model of the same automobile that has a lower purchase price than the original automobile. In another embodiment, the system may determine the class of car that is most appealing to the consumer and then attempt to qualify the consumer with a similar car from a different manufacturer.

The following detailed description is directed to certain specific embodiments of the invention. However, the invention can be embodied in a multitude of different ways as defined and covered by the claims. In this description, references are made to the drawings wherein like parts are designated with like numerals throughout.

The System

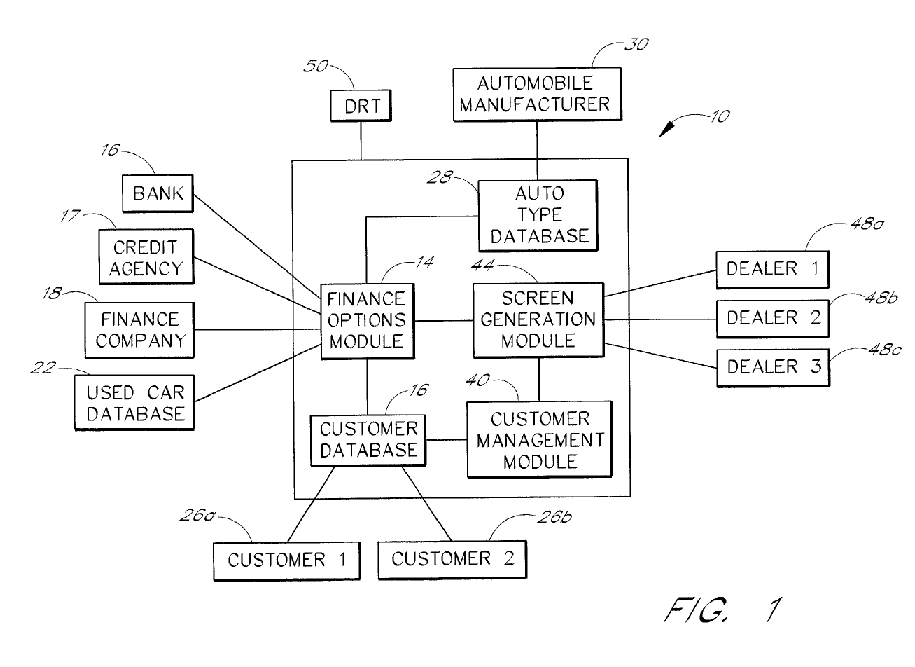

FIG. 1 is a block diagram of an overview of one embodiment of an electronic financing system 10. As illustrated, the financing system 10 includes a main computer 12 that is linked to a plurality of different systems. The main computer 12 is preferably an Internet Server computer, and can be a conventional microcomputer or minicomputer server running well known Internet Server software, such as Microsoft Windows NT®, Apache® or Sun® server software.

The main computer 12 includes a financing options module 14 that receives and transmits data to a bank 16, credit agency 17, finance company 18 and used car database 22. Linked to the financing options module 14 is a consumer database 16 that provides information that has been received from automobile consumer computers 26a,b.

Also linked to the financing options module 14 is an automobile type database 28 that provides data on all of the available types of automobiles for sale by the dealership. An example of an automobile type database 28 can be found in co-pending U.S. application Ser. No. 09/231,409, filed Jan. 14, 1999 and entitled “Real Time Communication Of Purchase Requests”, which is hereby incorporated by reference in its entirety. The automobile type database 28 is kept up to date by an automobile manufacturer 30.

Connected to the consumer database 16 is a consumer management module 40 which provides software instructions for managing the consumer database 16. These instructions might include, for example, consumer management tools, such as service reminder programs or a consumer vehicle database that stores the names, addresses and telephone numbers of all of the consumers that have applied for financing, or purchased vehicles from the dealership.

Communicating with the consumer management module 40 and finance options module 14 is a screen generation module 44 which provides on-screen financing option information to a series of dealers 48a-c.

In addition, the main computer 12 is linked to a Dealer Realtime Network 50 which provides the dealership with many other options described below.

The communication between the consumer computers 26a-b, main computer 12, bank 16 and finance company 18 preferably proceeds through a Wide Area Network, such as the Internet. Of course, the banks, credit agencies and main computer could also be linked through dedicated lines. By implementing encryption and other security protocols, such as Secure Socket Layers (SSL), the data communication between these entities can be protected from being accessed by outside individuals.

Banks and finance companies rely on the credit agency 17 to provide scores that are normally calculated by computer software within the credit agency that contains a pre-set scoring model. Each model is built by analyzing the information contained in large samples of anonymous borrowers' credit files. Analysts tracked how those borrowers paid their bills and identified patterns in the credit bureau data that correlated to late payment.

Other credit scoring models have been developed from different sources of data. In addition, custom scoring models can be developed from a business's own data, such as its own consumer information taken from credit application forms and credit bureau reports.

Typically, credit agency scores are based on five main categories of credit information. These are, in order from most to least important:

1. Late Payments, Delinquencies, Bankruptcies

2. Outstanding Debt

3. Length Of Credit History

4. New Applications For Credit (Inquiries)

5. Types of Credit in Use

The credit agency develops these scoring models in order provide a reproducible numerical rating that rates the borrowing power and likelihood of repayment of a consumer. The bank 16 and finance company 18 then utilize these scores in determining whether or not to loan money, grant a lease or sell insurance to a particular consumer.

Data Flow in the System

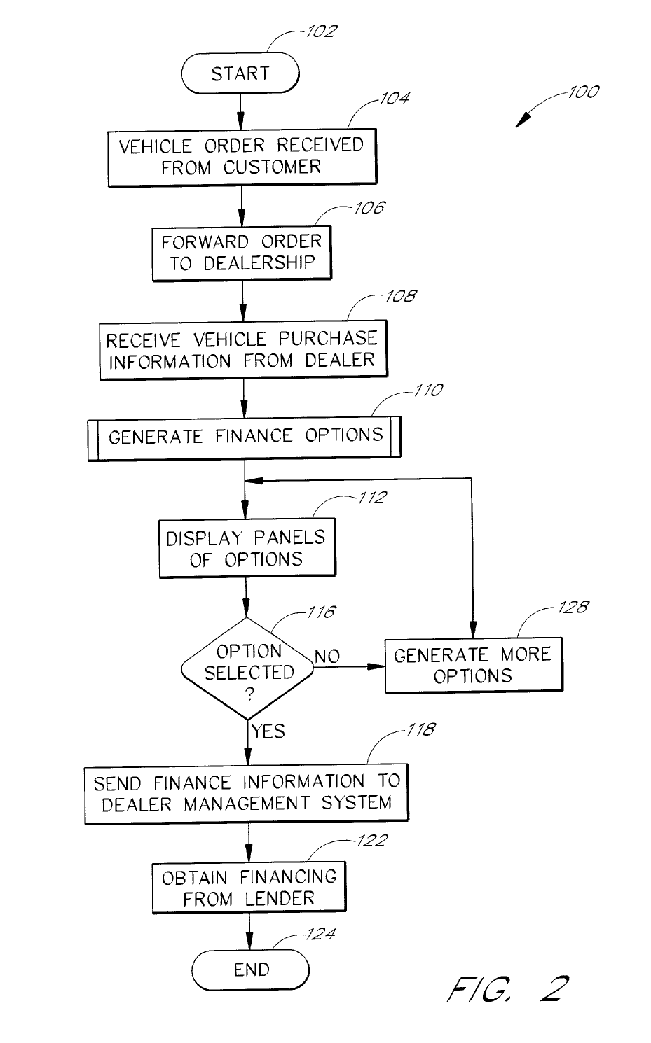

FIG. 2 provides an over view of the data flow through the electronic financing system 10. As indicated, the process 100 begins at a start state 102 and then moves to a state 104 wherein an order for a vehicle is received from a consumer. As discussed above, the order is preferably received through the Internet by a consumer that has made an on-line request to purchase a particular vehicle. In practice, the consumer typically fills out an online HTML form that requests data on the type of vehicle being purchased. Additionally, the consumer preferably enters credit data, such as their current salary, debts and other similar data relating to their credit worthiness.

Once the system has received an order from the consumer, it is preferably forwarded to an appropriate dealership in the consumer's geographic area at a state 106. The process 100 then moves to a state 108 wherein the system receives vehicle purchase information from the dealership. This information is preferably entered by a finance specialist at the dealership and relates to price, make, model and other information pertaining to the vehicle being purchased by the consumer. It should be noted that this step can be performed very soon after the dealership receives the vehicle order, or days or weeks later when the consumer goes to the dealership to work with a dealership finance specialist. In practice the finance specialist works with the consumer to determine the exact details of the purchase transaction.

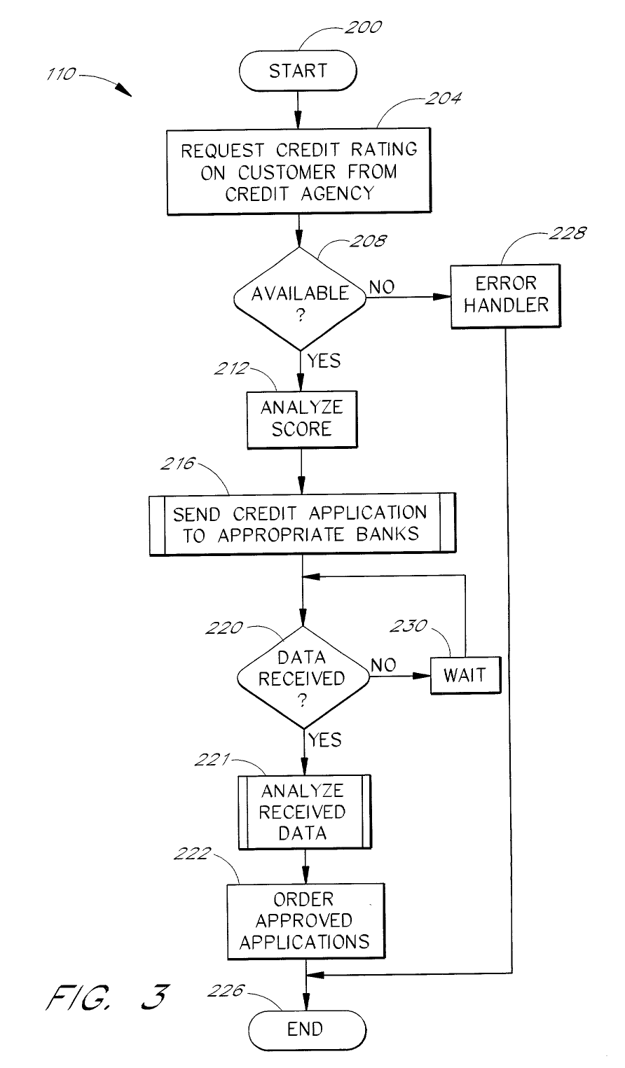

Once the system has received the details of the purchase transaction from the dealership finance specialist at the state 108, the system moves to a process state 110 to generate finance options. The steps undertaken within the process state 110 are explained in more detail below in reference to FIG. 3. Once the system has received various approved finance options from banks for the purchase, the process 100 moves to a state 112 wherein a panel of options is displayed to the finance specialist on their computer display. Such a panel might display, for example, 2, 4, 6, 8 or more various finance options in different quadrants of the computer display. Each finance option is available to the consumer, and is preferably based on their credit history and income level. In addition, in one embodiment, each finance option is ranked on the display screen in order of how much revenue it would bring to the dealership. In another embodiment, the system uses different colors on the screen to indicate to the finance specialist the most advantageous loan, lease or insurance program for the dealership or the consumer.

Once the panel of options is displayed at the state 112, the process 100 moves to a decision state 116 to determine if any of the finance options were selected as acceptable by the dealership finance specialist. If a determination is made that one of the finance options was acceptable, the process 100 moves to a state 118 wherein the finance information is forwarded to the Dealer Management System in order to record the purchase information.

In addition, the bank that offered the approved financial terms is electronically sent an approval, and the system moves to a state 122 wherein the actual financing is obtained from the bank. Because the bank has already approved the terms of a loan, lease or insurance based on the information provided in state 110, the selected bank can simply confirm the consumer information provided and thereafter generate, or provide data to the system 12 so that it can generate all of the appropriate documentation. The process 12 then terminates at an end state 124.

It should be noted that if a determination was made at the decision state 116 that none of the options were selected, more options are generated at a state 128. The process then returns to the state 112 where the newly generated options are displayed.

Referring now to FIG. 3, the process 110 of generating finance options for a consumer is described more fully. The process 110 begins at a start state 200 and then moves to a state 204 wherein instructions within the finance options module 14 requests credit rating data on the consumer from a credit agency. Normally this data is provided by sending the credit agency the name and social security number of the consumer. One such agency that provides credit scores is Lending Tree, Inc. (www.lendingtree.com).

A determination is then made at a decision state 208 whether or not any credit rating data is available for the selected consumer. If credit rating data is available, the process 110 moves to a state 212 wherein the credit score is received and analyzed to determine which banks would accept an application from this consumer.

In order to analyze the score the finance options module 14 includes a pre-programmed set of computer instructions (rules) that determines which bank might approve a product loan to a particular consumer based on the consumer's credit score, the product purchased (e.g.: cost) and other credit information. Accordingly, the finance options module 14 acts as a qualification module for determining which banks are likely to loan to a particular consumer. The following Table 1 illustrates several rules that can be used.

TABLE 1
Examples of Lending Criteria

| Bank | Rule 1 | Rule 2 | Rule 3 |
|---|---|---|---|
| 1 | Income > $50,000 | Credit score > 80 | Must own home |
| 2. | Income > $25,000 | Credit score > 75 | Product < $15,000 |
| 3. | Income > $20,000 | Credit score > 95 | Product < $10,000 |

As indicated in Table 1, Bank 1 might loan money to only high income consumers having an income that is more than $50,000 per year. However, Banks 2 and 3 might loan money to lower income consumers that have yearly incomes of $25,000 or more. Each bank defines its own filter so that only credit applications that are likely to be approved are sent to the bank. This prevents the bank from spending resources to analyze credit applications that are not likely to be approved.

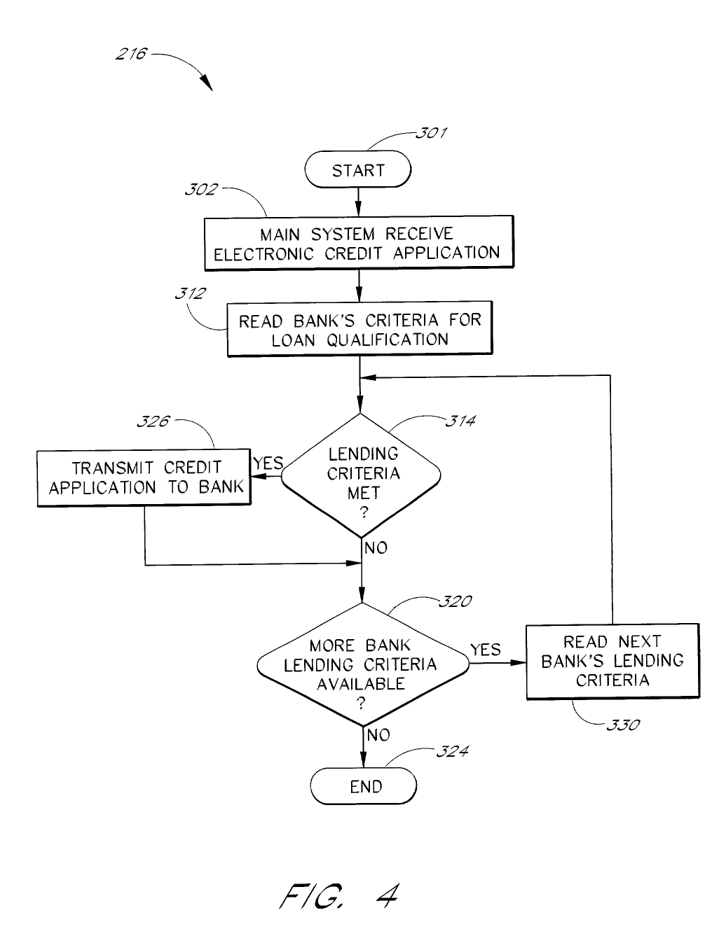

Once the consumer's credit application has been scored and filtered, copies of the credit application are sent to one or more banks at a process state 216. The process of sending data to a bank is explained more completely with reference to FIG. 4. Briefly, the single credit application can be divided into several copies and distributed to all of the banks whose criteria have been met through the analysis undertaken by the finance options module. As one example, a credit application is transmitted by a consumer, or financing specialist at a dealership, to the bank for approval. The bank returns a loan approval and specific loan data back to the finance options module 14 for the selected product. In one embodiment, the loan data is returned in a structured data format, such a XML.

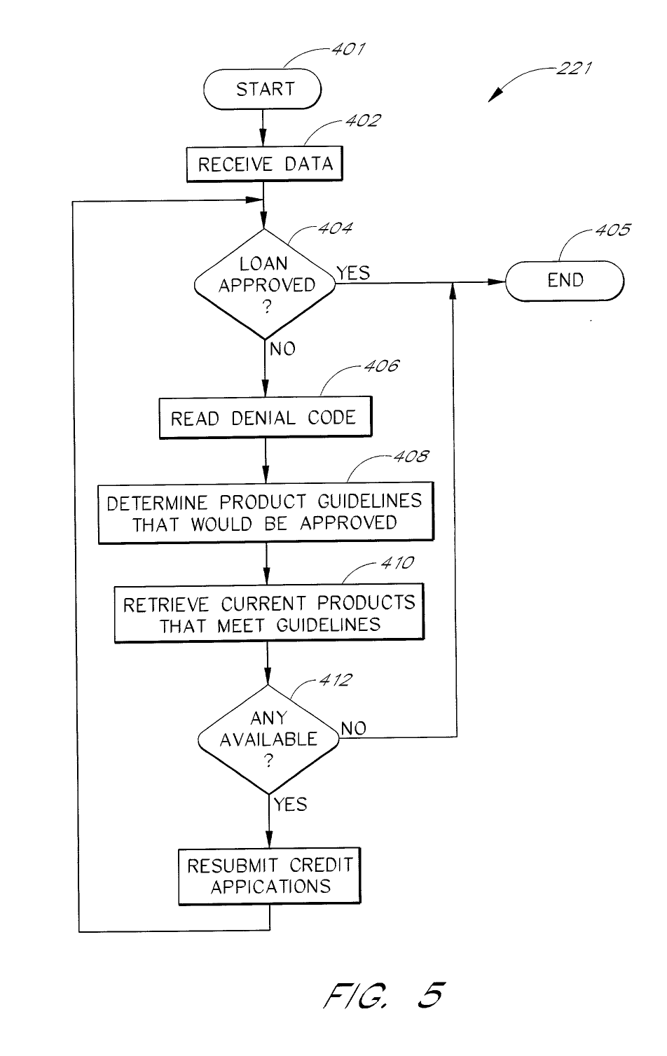

A decision is then made at a decision state 220 whether any data has been received from any of the banks or finance companies. If any data has been received, it is analyzed at a process state 221. The process 221 is explained in more detail with reference to FIG. 5. Once the data is analyzed at the process state 221, the process 110 then moves to a state 222 wherein any of the approved applications are ordered, in one embodiment, by the amount of revenue they would bring to the dealership. For example, a first bank might offer a $100 fee to the dealership for arranging the loan, and a second bank might offer a $250 fee to the dealership for arranging the loan. In this case, the system will order the second loan ahead of the first loan so that the financing specialist will know which loan is better for the dealership.

Transmit Credit Application to a Bank

Referring now to FIG. 4, an embodiment of the process 216 of transmitting a credit application to a bank is illustrated. The process 216 begins at a start state 301 and then moves to a state 302 wherein the main system 12 receives an electronic credit application and product identification number from a consumer or finance specialist. While the product can be any consumer product, the most preferable product for the purposes of this system is a vehicle such as an automobile, truck or van. In addition, the product identification number is preferably the Vehicle Identification Number (VIN) of the vehicle.

Since the credit score for the consumer has already been determined, the process 216 moves to a state 312 wherein the criteria used by a first bank to determine which consumers qualify for a loan is read. Thus, each bank that is linked to the main system 12 provides the finance options module 14 with specific rules and criteria for approving loans. Thus, at state 312 the process 216 reads the criteria from a first bank in order to determine whether the particular consumer meets this bank's lending or leasing criteria. Once the criterion has been read at the state 312, instructions within the finance options module 14 determine whether the bank's lending criteria has been met at a decision state 314. The determination of whether the particular consumer meets the bank's lending criteria is made based on the consumer's credit score, the specifications of the product being purchased, and other credit data taken from the credit application.

If the lending criterion is not met at the state 314, the process 216 moves to a decision state 320 to determine whether more bank lending criteria is available to be compared to the consumer's credit application. If no more banks exist to be analyzed, the process 216 terminates at an end state 324.

However, if a bank's lending criteria was met at the decision state 314, the process 216 moves to a state 326 wherein the consumer's credit application is electronically transmitted to the bank for processing.

Once the application has been transmitted to a bank, a determination is made whether more banks exist that are willing to accept the consumer's credit application. If more banks do exist, the process 216 moves to a state 330 wherein the lending criteria from the next bank is read and the process returns to the decision state 314 to determine whether that bank's criteria is met.

Processing the Application

FIG. 5 provides an illustration of the process 221 of analyzing received data in the electronic financing system 10. The process 221 begins at a start state 401 and then moves to a state 402, wherein information relating to the submitted credit application is received by the main system 10. A determination is then made at a decision state 404 whether or not the loan was approved by the bank. If the loan was approved, the process 221 terminates at an end state 405. However, the bank might deny the loan automatically through its own computerized decision making system, or manually through a review by an underwriter. In addition, included with the denial from the bank is normally a reason code that explains the rationale for the bank's denial of credit to the consumer.

If the bank denies the loan at the decision state 404, the system will receive a denial message from the bank computer at a state 406. After receipt of the denial message, instructions are run at a state 408 to determine product guidelines for a product that would be approved by a bank. For example, based on the reason code generated by the bank for initially turning down the credit application, the instructions at the state 408 might determine that the product selected by the consumer was too expensive. In this case, the process 400 moves to a state 410 wherein instructions are run within the main system to retrieve products that are within the guidelines, such as less expensive products, from an in-house inventory, such as the Auto type database 28. Of course, the inventory of products would not necessarily need to be stored within the same facility as the main system. Other inventory storages, including databases linked to the main computer through a Wide Area Network are anticipated to function similarly. Thus, if the product was a vehicle, a less expensive vehicle will be selected from inventory that is similar to the originally chosen vehicle by the consumer.

A determination is then made at a decision state 412 whether any products meet the guidelines determined for potentially approving a loan. If any product is retrieved from inventory, the process 400 moves to a state 416 wherein a new application is transmitted to the same bank or a new bank. The process 400 then returns to the state 404 wherein a determination is made whether the loan was approved or not.

It is also anticipated that the main system 12 could compile and sort all of the approvals from various banks in order to provide the dealership with a single message, including all of the loan conditions from the various banks that have approved the credit application.

Other Embodiments

In one embodiment, the finance options module creates a data set that preferably includes the name of the accepting bank, the terms of the loan that have been approved, and any other pertinent information from the bank. The terms of the loan might be, for example, 10 years at 8% annual percentage rate with $3,000 down. Of course, because various banks provide different terms, each bank that approves the loan may have different terms for the consumer. Thus, the consumer or dealership financial specialist might receive several data sets from different banks or finance company, each one including various terms and conditions on the consumer.

Because banks make income based on the number of loans they approve, it can be advantageous for a bank to have lower standards within the finance options module 14 than are actually in place within their own bank. Thus, more individual attention can be paid to the applications that are forwarded to the bank from the main system 12.

It should be noted that if a bank denies a consumer's loan application, the denial code normally includes a “reason code” that explains the rationale the bank used in denying the loan. The reason code might be, for example, “Product too Expensive”, “Debt Ratio Too High”, “Not Enough Income for Product Price”, or any other code that explains why the credit application was rejected.

The denial message is then forwarded to the main system 12 in order to determine the reason that the bank denied the consumer's credit application. The denial analysis module preferably includes instructions for reading the reason code and taking further action based on the type of code presented.

If, for example, the reason code indicated that the vehicle being purchased was too expensive for the credit score of the consumer, the finance options module 14 will run instructions to search the auto type database 28 for a product that is similar to the original product, but costs less. Thus, if the original product was a Toyota Camry costing $24,000, instructions within the finance options module 14 might search the inventory database 28 for a earlier model Toyota Camry costing $20,000 or less.

If such a vehicle is found within the inventory database 28, a new product message is preferably sent to the finance options module 14. The new product message preferably includes all of the data from the original credit application, but substitutes the new product information (e.g.: the new vehicle identification number and price) for the original product information.

Thus, the main system 12 advantageously analyzes any credit denials and thereafter attempts to substitute a similar product for the original product in order to obtain credit approval for the consumer. In this manner, if the consumer had originally chosen to purchase a product that was too expensive, based on his past credit history and lending ability, the electronic financing system would find a lower priced alternative so that the consumer would still be able to purchase a similar product.

This invention may be embodied in other specific forms without departing from the essential characteristics as described herein. The embodiments described above are to be considered in all respects as illustrative only and not restrictive in any manner. The scope of the invention is indicated by the following claims rather than by the foregoing description.

What is claimed is:

1. An electronic vehicle loan approval system comprising:
an electronic vehicle loan application, wherein the application permits entry of loan data and first vehicle data from a vehicle dealership;
a credit score module comprising computer readable instructions to accept the loan data, process it in accordance with a predetermined credit score formula and provide a credit score for a consumer;
a qualification module comprising computer readable instructions to electronically submit said credit score to a plurality of banks and receive a list of banks that approve the loan; and
an ordering module comprising computer readable instructions for ordering the list of loans based on their value to the vehicle dealership.

2. The system of claim 1, wherein the first vehicle data comprises the make, model, year and price of the automobile.

3. The system of claim 1, wherein the credit score module comprises instructions for retrieving a credit report on the consumer.

4. The system of claim 1, wherein the qualification module comprises a table of rules for approving loans.

5. The system of claim 1, wherein the qualification module comprises instructions for retrieving automobile data from an automobile inventory database.

6. The system of claim 5, wherein the automobile inventory database comprises the make, model, year and price of a plurality of automobiles.

7. The system of claim 1, wherein the qualification module comprises instructions for determining whether the consumer qualifies through a second bank for a second vehicle.

8. A computerized method of determining the most advantageous loan application for a vehicle dealership, comprising:
determining a credit score of an electronic vehicle loan application for a first vehicle submitted by a vehicle dealership;
comparing the credit score with a predetermined bank lending criteria to determine if the loan application meets the lending requirements of one or more banks;
submitting the loan application to the one or more banks if the lending criteria has been met;
receiving a denial of loan approval from the one or more banks, wherein responsive to said denial, a second vehicle is selected from an inventory of vehicles;
resubmitting the loan application for the second vehicle to the one or more banks; and
ordering the list of approved loans based on their revenue to the dealership.

9. The method of claim 8, wherein the credit score is determined by electronically transmitting the loan application to a credit agency.

10. The method of claim 8, wherein receiving the denial of the loan application comprises receiving a reason code that explains the rationale for the denial.

11. The method of claim 8, wherein the inventory comprises a database of vehicles.

12. A system for approving a vehicle loan application, comprising:
means for determining a credit score of an electronic vehicle loan application for a first vehicle submitted by a vehicle dealership;
means for comparing the credit score with a predetermined bank lending criteria to determine if the loan application meets the lending requirements of one or more banks;
means for submitting the loan application to the one or more banks if the lending criteria has been met;
means for receiving a denial of loan approval from the one or more banks, wherein responsive to said denial, a second vehicle is selected from an inventory of vehicles;
means for resubmitting the loan application for the second vehicle to the one or more banks; and
means for ordering the list of approved loans based on their revenue to the dealership.

13. The system of claim 12, wherein the credit score is determined by electronically transmitting the loan application to a credit agency.

14. The system of claim 12, wherein the means for receiving the denial of the loan application comprises a reason code that explains the rationale for the denial.

15. The system of claim 12, wherein the inventory comprises a database of vehicles.
